(19) United States
(12) Patent Application Publication
(10) Pub. No.: US 2016/0338386 A1
(43) Pub. Date: Nov. 24, 2016

(54) FOODSTUFF WITH UNPROCESSED SALT AND METHOD OF MAKING THE SAME

(71) Applicant: YNuts, LLC, New York, NY (US)

(72) Inventors: David AVITAL, New York, NY (US); Pernilla AVITAL, New York, NY (US)

(21) Appl. No.: 14/949,056

(22) Filed: Nov. 23, 2015

Related U.S. Application Data
(60) Provisional application No. 62/164,213, filed on May 20, 2015.

(51) Int. Cl. A23L 1/30

(52) U.S. Cl. CPC A23L 1/364; A23L 1/237; A23V 2002/00

(57) ABSTRACT

A natural, and unprocessed seasoning can be used in a flavored foodstuff, the unprocessed seasoning, or salt is used with an adhesive at least partially coating a nut, and adhered to the natural adhesive. A novel flavored foodstuff is disclosed, utilizing the unprocessed salt with a roasted nut and method of making the novel foodstuff is also disclosed.

### BACKGROUND OF THE INVENTION

The present application claims priority to, and incorporates by reference in its entirety, U.S. Provisional Application No. 62/164,213, filed May 20, 2015.

Mass produced foods have been both a boon and bane for society. Modern processes have enabled production of large quantities of food to be available at moderate costs for a large number of people. Additives to the food, such as flavoring, coloring, and preservative ingredients, both chemical and biologic have also increased shelf-life, appearance, texture, and palatability of the food.

Like other great contributions to society however, mass produced foods have also increased certain health risks with their consumption. Large quantities of food are processed at unethically high speeds for efficiency resulting in low safety standards, poor food quality, low cleanliness standards, toxins from cleaning chemicals and the machinery, and subsequently food poisoning outbreaks arise from the methods of food preparation in factories. Other consequences of mass produced food are the epidemic of obesity, death of children due to food borne illness and allergy contaminates, and the poor effect on the environment.

Nuts, both tree nuts and legumes, are a popular mass produced snack and small meal item. Nuts may be prepared for consumption a number of different ways, including roasting, dry-roasting, salting (with or without roasting), or boiling, to name a few.

In order to improve the flavor of nuts, they have long been roasted. Roasting is generally accomplished using either heated air or hot oil. Roasting is generally carried out at elevated temperatures by introducing nuts into a roasting oven, maintaining the heat or introducing heat to bring the nut up to a roasting temperature, e.g., 100° C.-200° C., and maintaining the heat at that temperature until the nuts reach proper taste and texture. Additionally, flavor of the roasted nuts can be further improved with the use of coatings and/or flavor oils.

For example, U.S. Pat. No. 4,161,545 discloses a method for applying a honey based coating to nuts. Similarly, U.S. Pat. No. 3,671,766 discloses a process for coating nuts with hexatol containing compositions. U.S. Pat. No. 4,053,650 discloses a method for coating nuts with cereal and wheat flour compositions which are baked onto the roasted nut. U.S. Pat. No. 4,085,230 discloses a process for processing nuts which includes an initial step of cooking the nuts in boiling water for a period of time before roasting. In a final coating step salt and flavoring are applied to the cooled nuts.

Nuts may also be blanched in addition to roasting and/or salting. Blanching is a process wherein the nut is plunged into boiling water, removed after a brief, timed interval, and finally plunged into iced water or placed under cold running water in order to halt the cooking process. U.S. Pat. No. 3,457,087, for example, discloses a method for eliminating “spotting” on nuts which is associated with blanching and roasting processes. The process involves the quenching of hot roasted nuts in copious amounts of cold oil which is said to be absorbed into the nut. Flavorings can be included in the quench oil.

During the initial part of a nut roasting process water is removed from the nut which generally has an initial moisture content of about 4% to 8% by weight. Until the water content is reduced to about 1.5% to 2.5% no browning or flavor development occurs. In addition to loss of water and other volatiles such as aromatics and air the cell structure expands and nut oil moves out of the nut kernel to its surface.

As a result of the loss of volatiles thermal expansion of the nut occurs, forming many small cracks and fissures in the nut. According to U.S. Pat. No. 3,457,087, at this point the nut should be capable of absorbing flavorings readily. However, flavoring added to the hot nuts are generally volatilized and only a minor amount, if any, remains to be absorbed by the nut. Once the nut has cooled the surface oil is absorbed, the nut contracts and the moisture content is equilibrated with the ambient conditions that is about 2% by weight moisture.

As a result of these physical phenomena of the nut during roasting and cooling, the prior art processes fail to impart substantial flavor to the nut itself. In the process of U.S. Pat. No. 3,457,087, for example, the cold oil is applied to hot nuts and as a consequence the flavoring is volatilized in the region immediately adjacent to the nut. There has been a failure in the prior art to recognize that nut surface temperature during the application of flavorings to nuts is critical if the flavoring is to be absorbed rather than remain merely as a surface coating.

While traditional roasting and/or salting or coating methods add flavor to nuts, there are considerable drawbacks associated therewith. Some major limitations of flavoring of nuts such as deep fat fried/dry roasted cashew nuts/peanuts with powdered spices include: (1) presence of thermo resistant bacterial load, which creates safety problems during storage. (2) Non-uniformity of the flavor quality (3) reduced impact of natural spice flavor, and (4) rapid loss of aroma during storage and presence of intense colored spots randomly distributed throughout the surface of the nut. In order to sustain a continuous demand for spiced nuts it is necessary to develop alternate flavorings as well as well as methods of application. The problems encountered by using powdered spices can be overcome to a large extent by developing suitable method of using spice oleoresins to flavor the processed nuts. By definition, an oleoresin is the total soluble extractives of a material in a specified solvent. In flavor work the best oleoresin is that which is a concentrate of all the flavor components (aroma, taste, pungency, and related sensory factors) and which truly recreates, when diluted, the sensory quality of the original natural material. Oleoresins do not have many of the disadvantages inherent in the use of powdered spices in terms of flavored quality, uniformity, and separation of storage. At the same time oleoresin offer convenience, while using in food industry or large-scale preparation.

Reference may be made to U.S. Pat. No. 4,738,865, in which an adhesive for adhering flavoring which is a mixture of a reducing sugar preferable lactose and a maltodextrin. The adhesive is particularly useful for coating peanuts with a dry honey coating providing honey coated and salted nuts. Reference may also be made to U.S. Pat. No. 4,931,304, describing a process for flavoring edible nuts which comprises roasting of nuts, partially cooling the nuts to about 56° C. to 92° C., applying a volatile flavoring agent and blending the nuts until the flavor agent is absorbed by the nuts.

Reference may be made to U.S. Pat. No. 5,194,278, which relates to edible cores, especially nuts (peanuts, cashews, etc.) having a desirable fruit flavoring. More particularly, the invention relates to edible cores which are prepared by coating with an adhesive solution containing a source of fruit flavoring and then roasting, to provide a snack having desired toasted taste and appearance.

Reference may be made to U.S. Pat. No. 5,061,499, which describes the coating the raw nuts (peanuts, cashews, etc.) with an adhesive solution containing honey, corn syrup, sucrose, carbohydrate gum and water followed by a coating of powdered sugar, roasting the nuts preferably in oil, and then applying a coating of a dry mixture of sugar and salt. The final coating is tightly adherent after roasting.

Reference may be made to U.S. Pat. No. 5,939,119, which describes a process for coating nuts by immersing the nuts in a molten edible material to coat the nuts with molten edible material, separating the excess molten edible material and then cooling the coated nuts to solidify the molten edible materials. Reference may be made to U.S. Pat. No. 5,093,139, relating to a method of preparing roasted sunflower shells containing seeds having a generally uniform coating of a flavoring agent. A liquid flavor containing a coating solution is used in the form of a spray.

Reference may be made to U.S. Pat. No. 4,692,342, describing a process for honey-roasting nuts by applying a predusting of a minor amount of an adhesive, film-forming material, honey and water; enrobing the adhesive coated nuts with a dry mixture of honey sugar and salt; and subjecting the coated nuts to roasting, preferably air roasting. Reference may also be made to U.S. Pat. No. 4,161,545, which describes the coating of nuts with the combination of honey and water followed by enrobing with a dry mixture of sugar and starch and the nuts are then roasted. Starch may also be used to coat nuts, as in U.S. Pat. No. 4,769,248. This patent relates to the a process for preparing dry roasting nuts, comprising applying a uniform coating of a starch to raw nuts, applying, a uniform coating of a gelatin solution to the starch coated nuts by applying a coating of a seasoning mix to the coated nuts, and roasting the resulting nuts.

There remains a need, therefore, to provide a nutritious, healthy, and tasty ready-to-eat foodstuff using organic ingredients.

### SUMMARY

Provided herein is a flavored foodstuff including a nut, an adhesive, and an unprocessed salt, the adhesive at least partially coating the nut, and the unprocessed salt at least partially coating the nut, the unprocessed salt adhered to said nut with the adhesive. In an embodiment, the flavored foodstuff includes beneficial organic matter from the group selected from algae, minerals, nutrients, vitamins, and mixtures thereof. In an embodiment, the beneficial organic matter is derived from said unprocessed salt. In an embodiment, the flavored foodstuff includes algae, or algae derived matter.

In another embodiment, the unprocessed salt and the natural adhesive are mixed together to form a seasoned adhesive prior to at least partially coating the nut. In an embodiment, the unprocessed salt and the natural adhesive are mixed in a ratio of from about 1/20 of adhesive/salt to about ⅕ of adhesive/salt.

In an embodiment, the nut of the flavored foodstuff is a natural oven roasted nut. In an embodiment, the nut is selected from the group of almonds, walnuts, pecans, hazelnuts, and pistachios. In a preferred embodiment, the nut is an almond. In an embodiment, the unprocessed salt is selected from sea salt or mountain salt. In another embodiment, the unprocessed salt is selected from group of red salt (which may be Hawaiian Alea red salt), grey marsh salt (which may be Celtic Sel Gris french marsh salt), Black sea salt (which may be Hawaiian black lava salt), Himalayan Rock salt (which may be pink Himalayan salt mined in Pakistan), and white Sea Salt. In another embodiment, the unprocessed salt is selected from the group of Himalayan salt, black lava salt, Jukyeom, Kala namak, Anglesey Sea Salt, Alaea salt, brine, Fleur de sel, Sal de Tavira, Sale Marino di Trapani, Sel gris, Sel de Guérande, and combinations thereof.

In another embodiment, a method of using an unprocessed salt to in a foodstuff is provided herein. The method includes providing an unprocessed salt and a nut, at least partially coating the nut with the unprocessed salt, and roasting the nut. The method can further include at least partially coating the nut with an adhesive in order to ensure adherence of the unprocessed salt to the nut.

In another embodiment, a method of making a flavored foodstuff comprising a nut is provided. The method includes: i) mixing an unprocessed salt and a natural adhesive to form a seasoned adhesive mixture; ii) heating the nut to a temperature between about 300° F. and 400° F. for a time sufficient to roast the nut; and iii) coating the nut with said seasoned adhesive mixture. In an embodiment, the natural adhesive includes yerba mate. In another embodiment, the method further includes a step of preheating the nuts prior to step i).

For a better understanding of the present invention, together with other and further objects and advantages, reference is made to the following detailed description, taken in conjunction with the accompanying examples, and the scope of the invention will be pointed out in the appended claims. The following detailed description is not intended to restrict the scope of the invention by the advantages set forth above.

### DETAILED DESCRIPTION

Salt is found in variable quantities in different countries, and in various conditions from various sources like mountains, marshes, mines, lakes, below the earth surface, and the sea. Different salts hold diverse health benefits and cultural values. When saltwater is evaporated in the production of sea salt many of the natural elements of the sea like the water's minerals (contains 82 essential nutrients found in the human body), algae, or clay soil (as found in Celtic sea salt) remain, but after the salt is processed the properties of algae or clay are washed away and the extra nutrients are lost. Many health experts classify algae as a “super food” due to the high content of minerals, nutrients, and vitamins. Himalayan salt is a marine fossil salt that is harvested from the ancient sea salt deposits in the foothills of the Himalayan Mountains. It is very rich in minerals from the mountain sediment, specifically iron. The salt has been protected and kept pure for millions of years, but if processed, much of the unique health benefits would be lost. Processed and commercial salts also contain harmful additives, including aluminum silicate and different bleaches. The use of unprocessed salts from around the world introduces a healthier salted nut product with the organic benefits of nature.

A unique, healthy salted nut product created without the use of artificially added nutrients will build a new market of natural, healthy, and trendy packaged snacks. It will give the consumer a choice to select among different kinds of salt together with better understanding of the identified uniqueness of the different nutritional value, and cultural, and health benefits. Salt has been valuable to cultures from around the world for over eight thousand years, and with the new use of unprocessed, global salts the importance of salt will increase as the negative association of unhealthy salted snacks will diminish.

As used herein, the term “nut” refers to any kernel found within a shell, and generally used in food, and includes both tree nuts and legumes. A nut is generally known as any hard-walled edible kernel which is typically a fruit composed of a hard shell and a seed, and is generally edible. Some examples of nuts include, without limitation, almonds, peanuts, hazelnuts, chestnuts, acorns, pecans, pistachios, walnuts, Brazil nuts, candlenut, cashews, macadamia, mongono, pine nut, walnut, and Yeheb nut.

As used herein, the term “algae,” or “algae derived matter” includes any foodstuff or ingredient derived from algae, particularly including any foodstuff with healthy and/or nutritious benefits contained therein. Algae is a very large and diverse group of eukaryotic organisms, ranging from unicellular genera such as Chlorella and the diatoms to multicellular forms such as the giant kelp, a large brown alga that may grow up to 50 meters in length. Most are autotrophic and lack many of the distinct cell and tissue types found in land plants such as stomata, xylem and phloem. The largest and most complex marine algae are called seaweeds, while the most complex freshwater forms are the Charophyta, a division of algae that includes Spirogyra and the stoneworts.

Naturally growing seaweeds, for example, are an important source of food, especially in Asia. They provide many vitamins including: A, B1, B2, B6, niacin and C, and are rich in iodine, potassium, iron, magnesium and calcium. In addition commercially cultivated microalgae, including both algae and cyanobacteria, are marketed as nutritional supplements, such as Spirulina, Chlorella, and the Vitamin-C supplement, Dunaliella, high in beta-carotene.

Algae are national foods of many nations: China consumes more than 70 species, including fat choy, a cyanobacterium considered a vegetable; Japan, over 20 species; Ireland, dulse; Chile, cochayuyo.Laver is used to make “laver bread” in Wales where it is known as bara lawr; in Korea, gim; in Japan, nori and aonori. It is also used along the west coast of North America from California to British Columbia, in Hawaii and by the Maori of New Zealand. Sea lettuce and badderlocks are a salad ingredient in Scotland, Ireland, Greenland and Iceland.

The oils from some algae have high levels of unsaturated fatty acids. For example, Parietochloris incisa is very high in arachidonic acid, where it reaches up to 47% of the triglyceride pool. Some varieties of algae favored by vegetarianism and veganism contain the long-chain, essential omega-3 fatty acids, docosahexaenoic acid (DHA) and eicosapentaenoic acid (EPA). Fish oil contains the omega-3 fatty acids, but the original source is algae (microalgae in particular), which are eaten by marine life such as copepods and are passed up the food chain. Algae have emerged in recent years as a popular source of omega-3 fatty acids for vegetarians who cannot get long-chain EPA and DHA from other vegetarian sources such as flaxseed oil, which only contains the short-chain alpha-linolenic acid (ALA).

As used herein, the term, “mountain salt” refers to any salt naturally derived from a mountainous or other geographic region from which salt may be derived. Examples include without limitation, Himalayan salt, black lava salt, Jukyeom, and Kala namak.

As used herein, the term, “sea salt” refers to any salt naturally derived from any body of water. Examples include, without limitation Anglesey Sea Salt, Alaea salt, brine, Fleur de sel, Sal de Tavira, Sale Marino di Trapani, Sel gris, and Sel de Guérande.

As used herein, the term, “unprocessed” means a naturally occurring salt with a minimum of processing steps. Unprocessed salt undergoes a minimal amount of processing, and the unprocessed salt therefore retains most of the naturally occurring minerals, trace minerals, and nutrients as well.

As used herein the term “seasoned,” “seasoning,” or “season(s)” refers to any salt, herbs, spices, fruits, cheeses, oils, or any other ingredients used to enhance the overall organoleptic qualities of the ready-to-eat seasoned foodstuff. Some examples include, but are not limited to grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

Salt is the most often used seasoning for food. The health benefits of sea salts are found both in their high mineral content (processed salt is devoid of minerals) and their high sodium to chloride ratio. While excessive salt intake is harmful, depletion of salt from the human body is ultimately lethal. Salt is a natural adversary to many fungus, bacteria and virus and our bodies are dependent upon an intake of sodium.

Each salt has its unique taste due to its unique mix of minerals and the complex variations of salt crystals. Salt, the most commonly used of all seasonings, is defined by its contents and with sea salts this includes various ratios of minerals and various ratios of the remnants of the micro sea life that lived and died in the water. All life on earth is dependent upon the smallest creatures of the sea as the bottom of the food chain, as our primary source of oxygen, and were the most basic of chemical changes upon minerals and amino acids are caused within these microscopic creatures.

Generally, it takes less sea salt for same level of saltiness and sea salts contain dozens of trace minerals necessary for life, which table salt does not. Generally table salt is surface mined from large salt flats, for which the minerals were wash away long ago. Table salt also is the salt most exposed to contamination.

Most retail salts are the by-product of desalination plants. There are many reasons not to use the processed salts found in most retail grocery stores. First, this salt tends to be highly contaminated due to the water sources used for desalination factories. The process also strips away most mineral content and the heat process used in desalination destroys the complex micro structures of sea salt and salt water.

Processed salt is devoid of all minerals and complex molecular structures - unique to each source of the sea salt. It is these minerals and molecular structures that not only provide the health benefits of sea salt, but also the favor. The different ratios of minerals and molecular structures of each provides than a different spicing of the taste of the food.

Studies have shown enormous health benefits resulting from changing for processed table salt to sea salt - this foremost due to increasing mineral intake and reducing sodium chloride intake. However, some also believe some sea salts are naturally ionized, therefore assisting to maintaining and restoring the ionic and magnetic field within cell structures of the human body. Many people around the world will actually add some salt (not a lot) to water they drink for this reason and medical studies have shown health benefits in doing so.

Sea Salt will contain all minerals, including all trace minerals. It is the lack of trace minerals that is most lacking in people's diets today, because all commercial agricultural land is essentially devoid of minerals. Minerals removed from the soil by plants will not replace themselves. When the minerals are depleted, they are depleted basically forever unless the land if flooded occasionally with mineral rich water (which is not done.)

The reason the oceans are salty is because all minerals (including salt) are continually being washed off land and into the oceans. When water evaporates from the ocean producing rain, the salt and minerals remain in the ocean. Thus, across the eons, oceans always become saltier and with higher mineral content. With each generation of crops, agricultural land loses more of its mineral content.

Most processed salt comes from such surface mines of salt flats. Water leaches and washes away the minerals and other contents. The processing of salt includes washing the salt to insure it is clean as surface salt is exposed to contamination. The washing process often washes away any remaining minerals and other ingredients of the salt. Finally, the process salt is dried under involves very high heat which may destroy the benefit of any remaining organic sourced molecular structures, and ground to small crystals. This processing removes all minerals and all other beneficial molecules from the salt.

Natural salt is the element that helps to regulate water content in the body. The balance of water and salt in the body is critical. Another key reason why natural salt is so important is because our bodies need trace elements for proper function. These elements are usually not found in food or nutritional supplements in a form that the body can utilize. However, all 82 of the essential trace elements needed by the body are found in natural unrefined sea salt and are in a bio-available form.

In general, natural sea salt helps to balance the entire body. Some of the more pronounced benefits include the following: 1) Regulates heartbeat and blood pressure. Even though refined salt can cause high blood pressure, natural salt with adequate water intake can help to stabilize irregular heartbeats and normalize blood pressure. In other words, if you have low blood pressure, taking Celtic sea salt can help to raise it. If you have high blood pressure, it can help to lower it. 2) Eliminates mucus buildup. Not only does natural sea salt help to eliminate existing mucus buildup, but it will help to prevent it. This benefit makes it very helpful for people with allergies, asthma, sinus issues, or bronchial congestion. 3) Improves brain function—sea salt is vital to the health of nerve cells and their ability to communicate and process information. Sea salt also helps to extract excess acidity and toxins from brain cells. 4) Balances blood sugars—sea salt is especially helpful for diabetics because it helps to balance blood sugars. 5) Alkalizes the body—excess acidity in the body is an underlying cause of many diseases. Salt is vital to the removal of excess acid wastes from the cells. In addition, mineral rich salt will help to maintain the optimal acid-alkaline balance. 6) Increases energy—salt and water are the key elements for the generation of hydroelectric energy in the cells. When sodium and trace minerals are deficient in the body, fatigue will set in. 7) Provides electrolyte balance—Natural sea salt will help keep the electrolyte minerals in your body balanced, releasing excess sodium and water. For problems with water retention, gradual sea salt intake can help to release excess water stored in body tissue. 8) Builds immunity—regular intake of natural sea salt and its highly absorptive minerals can give you a higher resistance to illness, infections, and disease. It can also help your body to heal faster after an injury or surgery. 9) Promotes restful sleep—the abundance of trace minerals in natural sea salt will have a calming effect on the entire nervous system. Additionally, the proper ratio of water and salt consumption can help to prevent the need to urinate during the night. 10) Prevents muscle cramps—muscle cramps are often caused by an electrolyte imbalance, especially a lack of sodium. Sea salt provides these minerals in the correct proportion. Your body will take what it needs and get rid of the rest, as long as you are drinking enough water.

Natural Celtic sea salt is light grey in color, which comes from the sea minerals and clay found in the salt flats. The clay ionizes the minerals in the salt, making it even more beneficial. Light grey Celtic salt is famous in the culinary world and is considered by many to be the best quality salt available. This salt is moist to the touch and will retain its moisture even when stored in a cool place for a long period of time. Light grey Celtic sea salt is dried only by the summer wind and sun, and it is not refined by any processing. This coarse salt is best used in cooking.

Hawaiian Red Sea Salt, also known as Alaea, is the traditional sea salt Hawaiians use for seasoning and preserving food; in healing rituals for medicinal purposes; and in ceremonies to cleanse, purify and bless tools and canoes. It is an unprocessed sea salt rich in trace minerals found in sea water. A small amount of harvested reddish Hawaiian clay (Alae) enriches the salt with iron oxide. It's available as coarse and fine crystals and works well in a salt grinder. Good for roasting or grilling meats, it's the traditional seasoning for native Hawaiian dishes such as Kalua Pig, Hawaiian Jerky, and Poke.

Fleur de Sel is believed by many chefs to be the best finishing salt on earth—lending a highly desirable level of complexity to food. It's distinguished by fine, glistening crystals in a pale shade resembling the color of summer clouds. Its crystals are irregularly sized and unevenly shaped. The smaller crystals dissolve quickly in the mouth, discharging a salty intensity. A good Fleur de Sel has about a 10.3% residual moisture which allows the crystals to repel outside moisture so they don't melt as easily as a drier salt, providing a satisfying crunch when eaten on food. Fleur de Sel is also very high in mineral content, due to the well-controlled evaporation process of the paludiers (salt rakers) who harvest it from the pans where the sea water is evaporated. It contains 0.25% calcium, 0.37% magnesium, and 0.09% potassium—as well as varying trace quantities of iron, zinc, manganese, and dozens of other minerals. All of these combine with the sodium chloride to form a well-rounded, mellow finishing salt. And finally, it is beautiful. Its moist, refractive crystals range in color from from barn owl gray to oyster white.

Black Lava Salt is from Hawaii and is a blend of unrefined sea salt and purified volcanic charcoal. This salt is evaporated in above-ground pools that formed naturally from lava flows. Activated charcoal, a proven anti-toxin and digestive-tract palliative, is added for color and for its detoxifying effects. Many people take it as a nutritional supplement.

Black Lava Salt has an unforgettable aroma and important health benefits from the charcoal in the lava. Its striking color and interesting smoky taste make it a great finishing salt for any dish. It's especially good on salads, vegetables, sushi, grilled steak, teriyaki chicken or tofu. Charcoal is good as a natural aid for stomach and gas ailments. It also helps prevent the stomach and intestines from absorbing most poisons or drugs.

Laboratory testing has shown that Premier Pink Salt contains quantum state phytonutrients that deliver the Quantum Nutrient Effect. The Quantum Nutrient Effect (QNE) refers to the phenomenon of truly synergistic nutrients working together to create an effect far greater than the sum of their individual benefits—by a factor of 2 to 100 fold or more. This combination promotes the most rapid shift to ideal cellular resonance for targeted organs and glands in the body, thus helping achieve a quantum leap to greater health.

Many alternative health practitioners advocate the use of sea salt as a healthful seasoning. They believe that Celtic sea salt, Himalayan sea salt and Hawaiian sea salt all contain natural trace minerals that help balance electrolytes. The more sodium you eat, the more magnesium and potassium you need to keep your body in balance. Sea salt naturally contains magnesium and potassium, but these minerals are removed from standard table salt. By using sea salt instead of table salt, you can maintain your electrolyte levels more easily.

Red salt from Kauai is infused with alaea, a type of Hawaiian clay. The clay tints the salt red because it contains iron oxide, which serves as an added nutrient. Black salt from Kauai contains activated charcoal, which is used as a detoxification agent and an antidote to poisons. Although Hawaiian salt does not contain a large enough quantity of activated charcoal for it to have strong detoxification properties, this mineral may contribute to the salt's reputation as a health supplement.

As used herein the term, “natural oven roasted nut” refers to a roasting process utilizing natural methods, including stone roasting (e.g., soapstone, slate, or lava rocks), charcoal roasting, or other natural roasting processes. Such roasting methods are disclosed in concurrently filed applications, attorney docket numbers 2481-3P, 2481-4P, 2481-5P, and 2481-6P, the entirety of which are herein incorporated by reference.

The process of the invention can be applied to any of those edible nut varieties, including tree and ground nuts, which are conventionally packaged and sold as snack-type products. Illustrative of such nut meats are peanuts, cashews, almonds, walnuts, filberts, macadamia nuts, pecans, and the like. In a preferred embodiment, almonds are used.

The nuts may be deshelled in a preliminary step and, optionally are also subjected to other conventional procedures such as blanching and the like, prior to being subjected to the process of the invention. When the nuts are ready to be roasted, they are subjected to roasting under conditions which may vary depending upon the particular type of raw nut and the type of roasting process, be it oil or air (i.e., dry) roasting. Illustratively, the nuts are roasted at temperatures within the range of from about 200° F. to about 450° F., for a time which will vary depending upon the particular roasting temperature employed, the particular type of nut being processed, and the degree of roasting desired. In a preferred embodiment, the nuts are roasted at a temperature within the range of about 300° F. to about 400° F. In a preferred embodiment, the nuts are roasted at about 350° F. For example, the time and extent of roasting will be greater in the case of peanuts than in the case of cashews. The most appropriate roasting conditions to be adopted in any particular instance can be determined readily by a process of trial and error.

The roasting operation can be conducted on a batch or continuous basis. The residence time of the nuts in the oven is adjusted to provide the desired time of roasting; e.g., a range of about one minute to about 30 minutes. In an embodiment, the nuts may be roasted in an oven in a range of 5 to 10 minutes, and in a preferred embodiment, the nuts may be roasted for about 7 to about 8 minutes. Any of the apparatuses conventionally employed in the art to effect the dry roasting of nuts can be utilized in the above batch or continuous roasting step. It is an advantage of the present invention that superior results are achieved when air roasting nuts coated in the manner described above.

An adhesive and/or an additional flavorant may also be used in the method of the present invention. Adhesives are well known in the art. Illustrative of suitable adhesive materials are those synthetic and derived vegetable gums such as xanthan, arabic, and guar, as well as dextrins, modified starches, and the like. Other optional ingredients to control viscosity and tackiness, including proteinaceous materials such as albuminoids, e.g., gelatin, albumins, glutenous materials, and like agents, can be present in the adhesive solution. The dry adhesive predust can employ any of these materials, preferably a dextrin or pregelatinized starch. The gelatin and like thickening/adhesive agents, are preferably employed in lesser amounts than the gums, and at levels up to about five percent by weight. In a preferred embodiment, a natural adhesive may be used, such as Yerba Mate. The use of this adhesive is disclosed in application number 2481-9P, filed on even date herewith, and incorporated by reference herein.

The nuts disclosed herein can also optionally and/or additionally be coated with any type of flavorant, or seasoning. Some examples include, non-exhaustively, allspice, anise, basil, beau monde seasoning salt, caraway, cardamom, pepper, chives, cilantro, five spice Chinese powder, garlic, ginger, juniper berries, mace, marjoram, mei yen seasoning, mint, mustard, nutmeg, oregano, paprika, parsley, pine nuts, poppy seed, pumpkin pie spice, rosemary, saffron, sage, savory, salt, sea salt, sesame seeds, shallot, soy sauce, tabasco, tarragon, thyme, turmeric, Worcestershire sauce, and zest.

The following describes a general procedure for harvesting the unprocessed salt. In order to harvest the salt, the salts are harvested in various ways depending on the origin. Salt evaporation ponds (alternatively salterns/salt pans) are shallow, artificial ponds designed in the vein of natural salt pans which are geological formations that separate salt from water. Seawater or brine is fed into the ponds and the water subsequently evaporates revealing the salt as free to harvest. The variable algal concentrations can be seen physically by the vivid colors of the evaporation ponds. The salt remaining after evaporation has many of the properties of the algae including minerals, vitamins, and nutrients. Up to five percent of the weight of dry sea salt is a mix of around 100 elements and over 80 additional compounds vital for good health. Salt found in mountains is mostly harvested by hand so the natural minerals from the sediment and fossilization remain until the salt is processed. Then, instead of processing the salt, the salt will only be treated to remove harmful matter while the nutritional value of the natural elements will remain. After the various salts are harvested and treated, they will be applied to the nuts resulting in a supercharged snack packed with all the natural benefits of nuts and of unprocessed salts.

### EXAMPLES

The present invention is further exemplified, but not limited, by the following representative examples, which are intended to illustrate the invention and are not to be construed as being limitations thereto.

### Example 1

The following ingredients are used in making a flavored foodstuff according to the presently claimed invention.

### INGREDIENTS

1 cup of water (8 oz)
½ tea spoon of Yerba Mate (0.0154 oz)
1 teaspoon of salt, comprised of one of the following:
Red salt (0.0950 z)
Black lava salt (0.1146 oz)
White Sea salt (0.1670 oz)
grey marsh salt (0.1425 oz)
Himalayan Rock salt (0.1935 oz)

### Procedure

The salt, in this case extra fine grain Himalyayan salt (alternatively, Sel Gris Celtic salt, Alaea red Hawaiian salt, organic sea salt, Hiwa Kai black lava salt), is put in a large mixing bowl with 1 cup of water (8 oz) and ¼ tea spoon of Yerba Mate (0.0154 oz), and mixed for 30 minutes.

The nuts, in this case the almonds, are spread flat on a natural surface slab, in this case soapstone (slate rock and lava rock may also be used). The soapstone slap is placed within a hot gas burning oven. The oven is pre-heated for about 10 minutes to about 350° F.

The almonds are roasted at 350° F. (or generally between 270° F. and 390° F.) for 8 minutes, or until a nutty aroma wafts out of the oven. The almonds should be a golden brown color. The almonds are then removed from oven on the slab and placed on a heat-resistant surface.

The hot almonds are immediately coated with the fine grain Himalayan salt and the powder Yerba Mate mixture. The almonds have to be cooled entirely prior to being served or packaged. The temperatures and times given above are those that are preferred. Obviously they may be varied based on the oven and amount of nuts roasting, roasting slab choice, and type of nut being roasted.

The above and other beneficial objects and advantages are accomplished in accordance with the present invention by a preconditioning process for the nuts, which comprises:
(a) storing the nuts in a conditioned environment having a temperature in the range of about 45 degrees F. to 55 degrees F. for sufficient time that the temperature of substantially each nut is uniform between its center and surface, and
(b) uniformly heating the conditioned nuts with heated air so as to cause the surface cells of the nuts to expand.

Raw nuts and seeds, generally having been stored at low preserving temperatures, are placed in open bins in layers having a depth between about 24 and 48 inches. Air having a temperature in the range of 78 degrees F. to 95 degrees F. is circulated around and through the bins for about 24 hours. Such treatment produced a conditioned nut product wherein the temperature of substantially each nut is uniform between its center and surface. In the absence of the conditioning treatment, the nuts will undergo internal scorching during the subsequent heat treatment.

The conditioned nuts are subsequently subjected to treatment with heated air which causes the surface cells of nuts to expand. Although the air temperature and time of exposure will vary with each nut or seed product because of its size and cellular structure, air temperatures will generally be in the range of 300 degrees F. to 400 degrees F., and exposure times will generally be in the range of 3 to 8 minutes. The heated nuts, having a slightly expanded surface, are highly permeable to a sodium chloride solution, especially when the nuts are still at an elevated temperature at the instant of application of the solution.

Nuts and seeds susceptible to improvement by the process of this invention are free of an intact inedible outer shell. Typical species include nuts such as almond, pecan, walnut, peanut, pistachio, macadamia, hazel, brazil, cashew, and sees such as pumpkin, and sunflower.

Thus while there have been described what are presently believed to be preferred embodiments of the invention, those skilled in the art will realize that changes and modifications may be made thereto without departing from the spirit of the invention, and it is intended to claim all such changes and modifications as fall within the true scope of the invention.

What is claimed is:

1. A flavored foodstuff comprising a nut, an adhesive, and an unprocessed salt, said adhesive at least partially coating said nut, and said unprocessed salt at least partially coating said nut, said unprocessed salt adhered to said nut with said adhesive.

2. The flavored foodstuff according to claim 1 wherein said flavored foodstuff comprises beneficial organic matter from the group selected from algae, minerals, nutrients, and vitamins.

3. The flavored foodstuff according to claim 2 wherein said beneficial organic matter is derived from said unprocessed salt.

4. The flavored foodstuff according to claim 1 wherein said adhesive comprises yerba mate.

5. The flavored foodstuff according to claim 1 wherein said unprocessed salt and said adhesive are mixed together to form a seasoned adhesive mixture prior to at least partially coating said nut.

6. The flavored foodstuff according to claim 1 further comprising algae, or algae derived matter.

7. The flavored foodstuff according to claim 1 wherein said nut is a natural oven roasted nut.

8. The flavored foodstuff according to claim 1 wherein said nut is selected from the group of almonds, walnuts, pecans, hazelnuts, and pistachios.

9. The flavored foodstuff according to claim 1 wherein said nut is an almond.

10. The flavored foodstuff according to claim 1 wherein said unprocessed salt is selected from sea salt or mountain salt.

11. The flavored foodstuff according to claim 10 wherein said unprocessed salt is selected from group of Hawaiian Alaea salt, French marsh salt, black lava sea salt, pink rock salt, white Sea Salt, and combinations thereof.

12. The flavored foodstuff according to claim 10 wherein said unprocessed salt is selected from the group of Himalayan salt, black lava salt, Jukyeom, Kala namak, Anglesey Sea Salt, Alaea salt, brine, Fleur de sel, Sal de Tavira, Sale Marino di Trapani, Sel gris, Sel de Guérande, and combinations thereof.

13. A method of using an unprocessed salt to in a foodstuff comprising, providing an unprocessed salt and a nut, at least partially coating said nut with said unprocessed salt, and roasting said nut.

14. The method of using an unprocessed salt according to claim 10 further comprising at least partially coating said nut with an adhesive in order to ensure adherence of said unprocessed salt to said nut.

15. The method of claim 14 wherein said adhesive is yerba mate.

16. A method of making a flavored foodstuff comprising a nut, said method comprising:
i) mixing an unprocessed salt and a natural adhesive to form a seasoned adhesive mixture;
ii) heating said nut to a temperature between about 300 F and 400 F for a time sufficient to roast said nut;
iii) coating said nut with said seasoned adhesive mixture.

17. The method according to claim 16 wherein said natural adhesive comprises yerba mate.

18. The method of claim 16 wherein said method further comprises a step of preheating said nuts prior to step i).
